(19) United States
(12) Patent Application Publication
(10) Pub. No.: US 2023/0018221 A1
(43) Pub. Date: Jan. 19, 2023

(54) ADJUSTING POWER PARAMETERS FOR FREQUENCY CONTROL IN COMPUTE SYSTEMS

(71) Applicants: Reshma Pattan, Tuam (IE); Pinkesh Shah, Chandler, AZ (US); Chris MacNamara, Limerick (IE); Nikhil Gupta, Portland, OR (US)

(72) Inventors: Reshma Pattan, Tuam (IE); Pinkesh Shah, Chandler, AZ (US); Chris MacNamara, Limerick (IE); Nikhil Gupta, Portland, OR (US)

(21) Appl. No.: 17/953,002

(22) Filed: Sep. 26, 2022

(51) Int. Cl. G06F 1/3293; G06F 1/3287

(52) U.S. Cl. CPC G06F 1/3293; G06F 1/3287

(57) ABSTRACT

An apparatus can include processor cores and control circuitry coupled to the processor cores. The control circuitry can detect at least one of a power characteristic and a frequency characteristic of at least one of the processor cores. The control circuitry can determine that a frequency control opportunity is present on at least one of the processor cores based on at least one of the power characteristic and the frequency characteristic. The control circuitry can adjust a power parameter of at least one of the processor cores responsive to determining that the frequency control opportunity is present.

### TECHNICAL FIELD

Embodiments described herein generally relate to computing systems, and in particular to power headroom and core operational frequencies in computing systems.

### BACKGROUND

Some computing systems available today provide methods to increase compute core clock speeds for CPU-intensive applications. In such systems, compute core frequencies can be increased higher than a base frequency when power headroom is available. However, communications systems and other systems that depend on stable frequency have not been able to take advantage of these or other frequency boosting methods. Systems that rely on a stable frequency may exhibit latency and performance issues when frequency fluctuates. There is a general need for systems that can provide the boost given by operating at higher core frequencies, while mitigating issues caused by unstable frequencies.

These computing systems can be part of a larger edge computing system, data center, etc. Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates a compute and communication use case involving mobile access to applications in an edge computing system.

FIG. 6 illustrates a flow diagram of a method for stabilizing frequency according to example embodiments.

FIG. 7 further illustrates decision points and other details of a method for stabilizing frequency according to some embodiments

FIG. 8 illustrates tuning wherein various parameters are adjusted and tuned to achieve stable frequency in accordance with some embodiments.

FIG. 9 illustrates workload configuration scenarios according to some embodiments.

FIG. 10A provides an overview of example components for compute deployed at a compute node in an edge computing system.

FIG. 10B provides a further overview of example components within a computing device in an edge computing system.

### DETAILED DESCRIPTION

Computing systems can operate using one or more processing cores. Some systems and operators provide a boost feature in which core frequencies can be dynamically varied, opportunistically, based on various criteria such as core temperature, estimated power, power and current consumption, and other variables. Frequencies for other compute system components outside of the processing cores can also be tuned. The boost feature can increase frequency to a maximum, and then “walk back” or reverse this frequency increase if the frequency appears to be about to exceed the maximum allowable for given power. This can cause an instability or “jitter” in the frequency at or near the maximum, as the frequency is reduced or increased opportunistically. In previous and currently-available implementations, communications workloads have not benefitted from this feature because of the impact of frequency transitions on communications workloads.

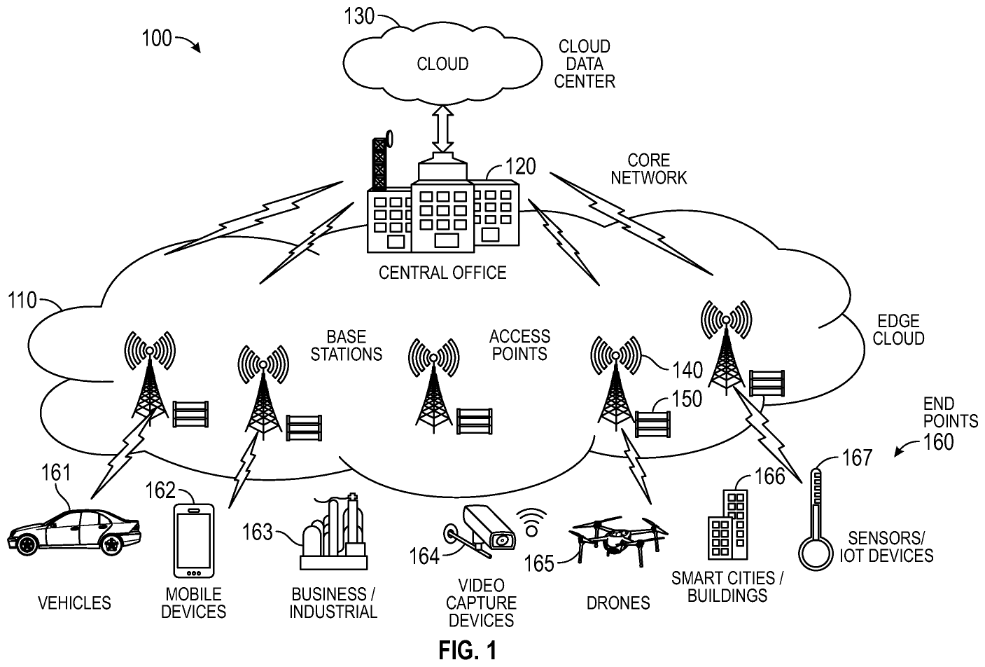

Embodiments address these and other concerns by providing a mechanism to tune the system settings and core frequencies to achieve a consistent core frequency. Methods according to embodiments can be configurable at run time, for example via user input device or display, and can be disabled or enabled based on user or operator preference. Methods according to embodiments can detect opportunities for achieving higher than advertised typical stable frequency. These methods can run in one or more of the systems illustrated in FIG. 1-5 as described below.

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data (e.g., at a “local edge,” “close edge,” or “near edge”). For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration, and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

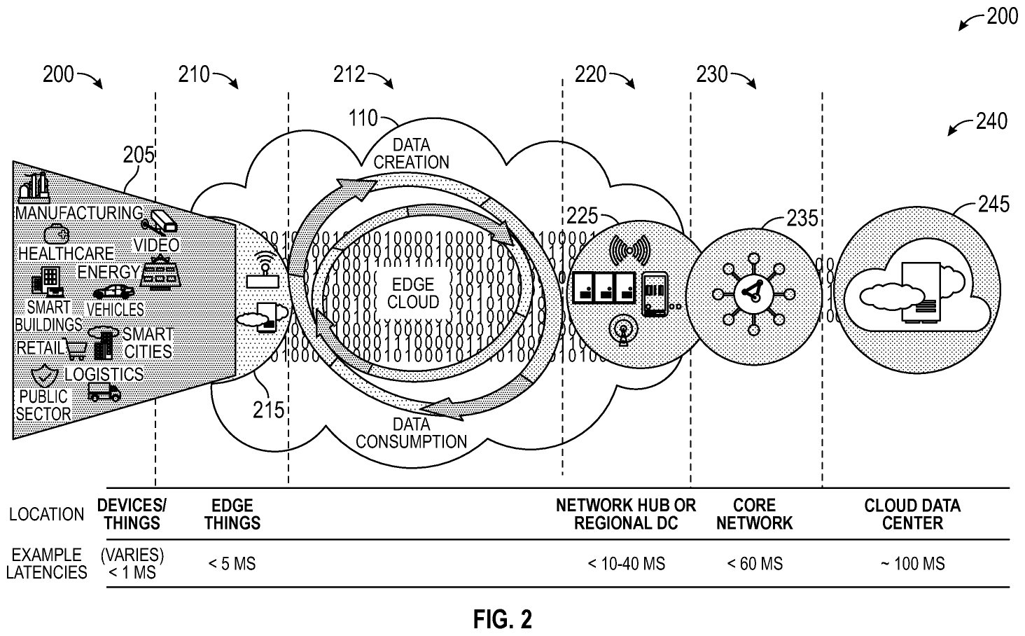

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210 (e.g., a “near edge” or “close edge” layer), to even between 10 to 40 ms when communicating with nodes at the network access layer 220 (e.g., a “middle edge” layer). Beyond the edge cloud 110 are core network 230 and cloud data center 240 layers, each with increasing latency (e.g., between 50-60 ms at the core network layer 230, to 100 or more ms at the cloud data center layer, both of which may be considered a “far edge” layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling, and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

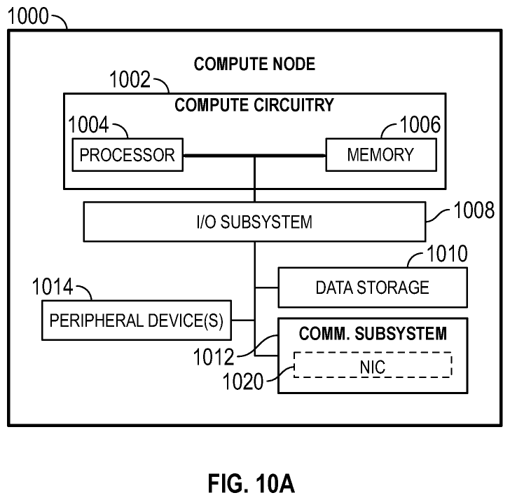

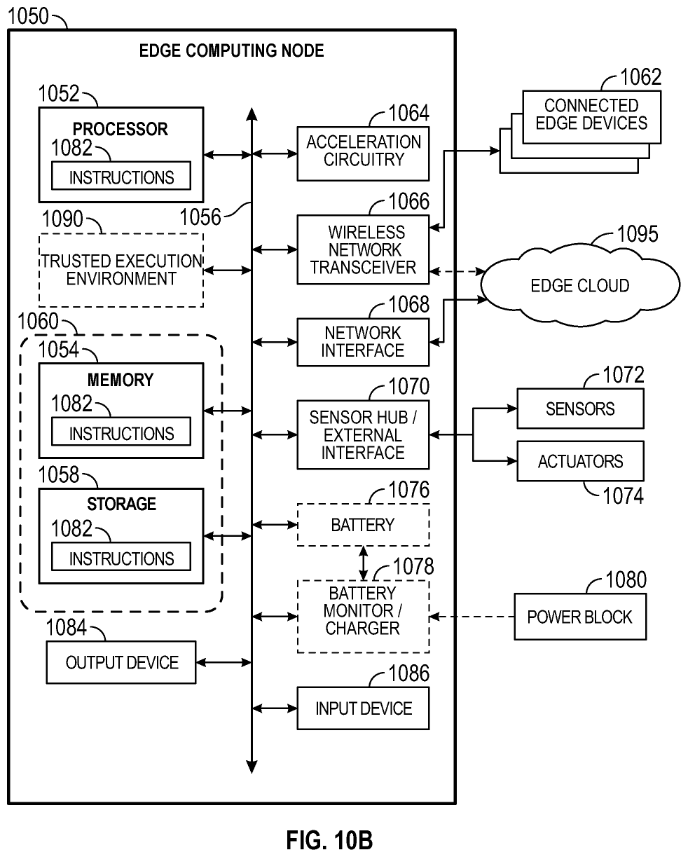

The network components of the edge cloud 110 may be servers, multi-tenant servers, appliance computing devices, and/or any other type of computing devices. For example, the edge cloud 110 may be an appliance computing device that is a self-contained processing system including a housing, case or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 10B. The edge cloud 110 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

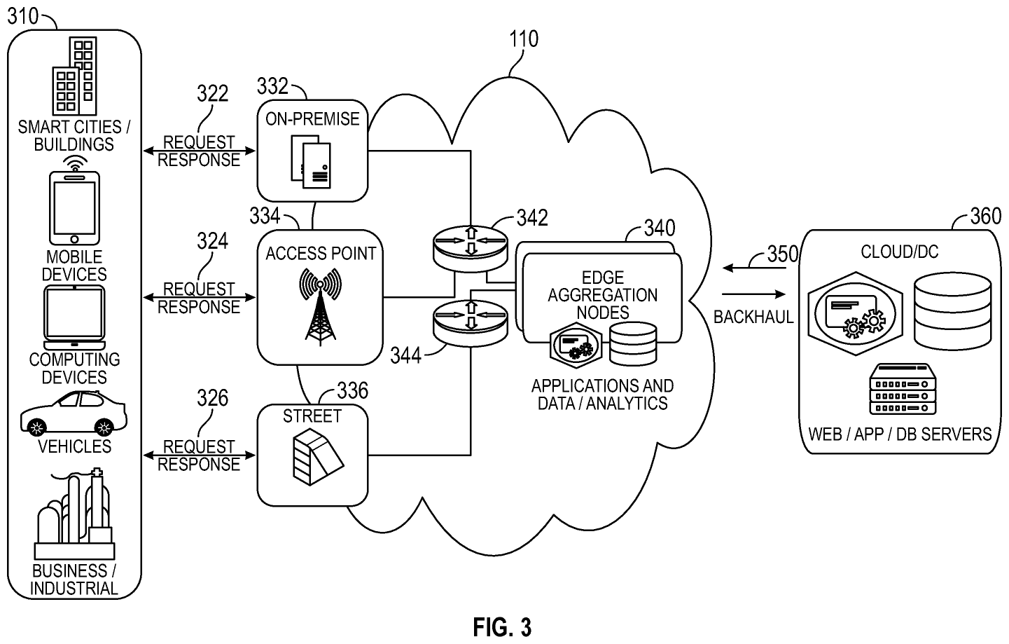

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premises network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

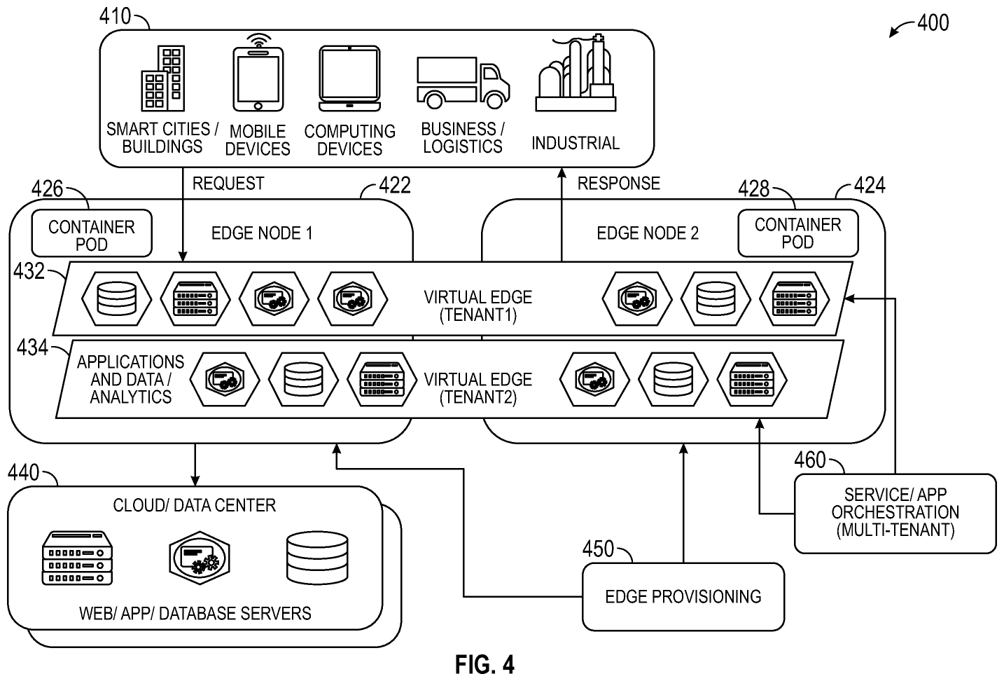

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

In some examples, applications can include a service, microservice, cloud native microservice, workload, or software. Any of applications can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

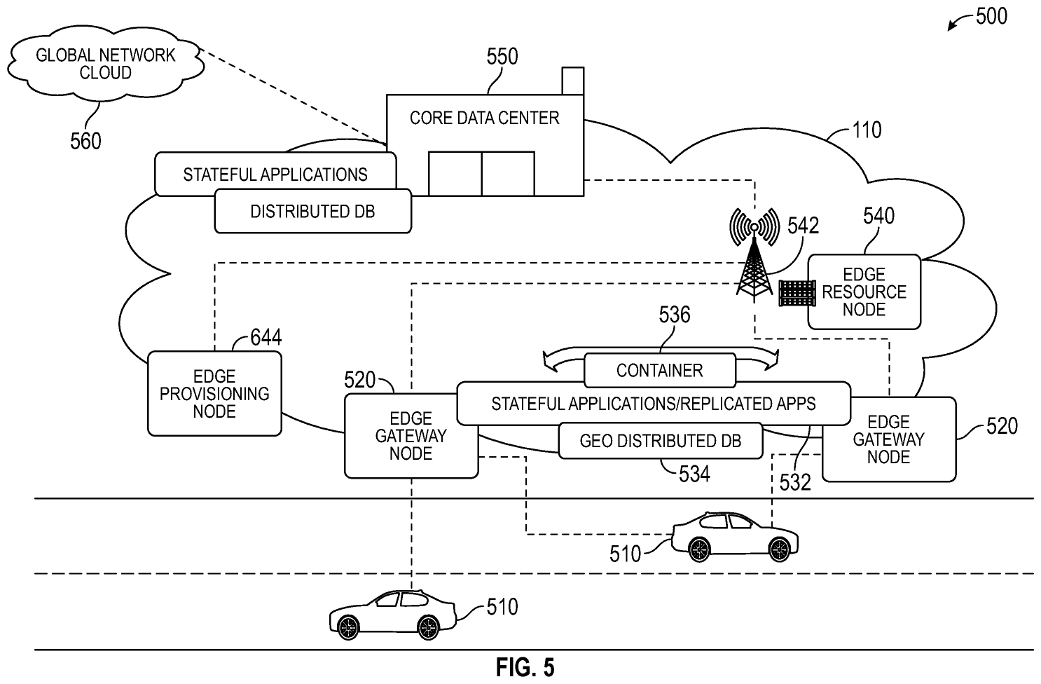

It should be appreciated that the edge computing systems and arrangements discussed herein may be applicable in various solutions, services, and/or use cases involving mobility. As an example, FIG. 5 shows a simplified vehicle compute and communication use case involving mobile access to applications in an edge computing system 500 that implements an edge cloud 110. In this use case, respective client compute nodes 510 may be embodied as in-vehicle compute systems (e.g., in-vehicle navigation and/or infotainment systems) located in corresponding vehicles which communicate with the edge gateway nodes 520 during traversal of a roadway. For instance, the edge gateway nodes 520 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 510 and a particular edge gateway device 520 may propagate so as to maintain a consistent connection and context for the client compute node 510. Likewise, mobile edge nodes may aggregate at the high priority services or according to the throughput or latency resolution requirements for the underlying service(s) (e.g., in the case of drones). The respective edge gateway devices 520 include an amount of processing and storage capabilities and, as such, some processing and/or storage of data for the client compute nodes 510 may be performed on one or more of the edge gateway devices 520.

The edge gateway devices 520 may communicate with one or more edge resource nodes 540, which are illustratively embodied as compute servers, appliances or components located at or in a communication base station 542 (e.g., a based station of a cellular network). As discussed above, the respective edge resource nodes 540 include an amount of processing and storage capabilities and, as such, some processing and/or storage of data for the client compute nodes 510 may be performed on the edge resource node 540. For example, the processing of data that is less urgent or important may be performed by the edge resource node 540, while the processing of data that is of a higher urgency or importance may be performed by the edge gateway devices 520 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 540 also communicate with the core data center 550, which may include compute servers, appliances, and/or other components located in a central location (e.g., a central office of a cellular communication network). The core data center 550 may provide a gateway to the global network cloud 560 (e.g., the Internet) for the edge cloud 110 operations formed by the edge resource node(s) 540 and the edge gateway devices 520. Additionally, in some examples, the core data center 550 may include an amount of processing and storage capabilities and, as such, some processing and/or storage of data for the client compute devices may be performed on the core data center 550 (e.g., processing of low urgency or importance, or high complexity).

The edge gateway nodes 520 or the edge resource nodes 540 may offer the use of stateful applications 532 and a geographic distributed database 534. Although the applications 532 and database 534 are illustrated as being horizontally distributed at a layer of the edge cloud 110, it will be understood that resources, services, or other components of the application may be vertically distributed throughout the edge cloud (including, part of the application executed at the client compute node 510, other parts at the edge gateway nodes 520 or the edge resource nodes 540, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 536 (or pod of containers) may be flexibly migrated from an edge node 520 to other edge nodes (e.g., 520, 540, etc.) such that the container with an application and workload does not need to be reconstituted, re-compiled, re-interpreted in order for migration to work. However, in such settings, there may be some remedial or “swizzling” translation operations applied. For example, the physical hardware at node 540 may differ from edge gateway node 520 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format or may involve mapping interfaces and operations. A pod controller may be used to drive the interface mapping as part of the container lifecycle, which includes migration to/from different hardware environments.

The scenarios encompassed by FIG. 5 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 520, some others at the edge resource node 540, and others in the core data center 550 or global network cloud 560.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

In an example, a node 644 includes one or more servers and one or more storage devices. The storage devices host computer readable instructions such as the example computer readable instructions 1082 of FIG. 10B, as described below. Similarly to edge gateway devices 520 described above, the one or more servers of the edge provisioning node 644 are in communication with a base station 542 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 1082 from the edge provisioning node 644. For example, the software instructions, which may correspond to the example computer readable instructions 1082 of FIG. 10B, may be downloaded to the example processor platform/s, which is to execute the computer readable instructions 1082 to implement the methods described herein.

In some examples, the processor platform(s) that execute the computer readable instructions 1082 can be physically located in different geographic locations, legal jurisdictions, etc. In some examples, one or more servers of the edge provisioning node 644 periodically offer, transmit, and/or force updates to the software instructions (e.g., the example computer readable instructions 1082 of FIG. 10B) to ensure improvements, patches, updates, etc. are distributed and applied to the software instructions implemented at the end user devices. In some examples, different components of the computer readable instructions 1082 can be distributed to different processor platforms; for example, different libraries, plug-ins, components, and other types of compute modules, whether compiled or interpreted, can be distributed to different processor platforms.

### Tuning Power Parameters for Frequency Control

In any of the compute systems above, a feature (e.g., a “boost” feature) can be provided in which core frequencies can be dynamically varied. The frequency of a core can be increased opportunistically based on core temperature, the number of active cores, the estimated power, and the estimated current consumption. The frequency of a core can be in a typical range of about 1.5 gigahertz (GHz) to 3.2 GHz, although embodiments are not limited thereto, and opportunistically increased, incrementally or otherwise, to higher levels. Frequencies for other compute system components outside of the processing cores can also be tuned. These components can include communication (e.g., PCI), memory controllers (MC), power control units (PCU), L3 cache, fabric between cores, cache/home agents and other components including components 1005 (FIG. 10A) and components 1053 (FIG. 10B). These components can have an associated frequency similar to core frequencies, that increase or decrease the rate of communication between elements or to outside systems. The boost feature can increase frequency to a maximum, and then “walk back” or reverse this frequency increase if the frequency appears to be about to exceed the maximum allowable for given power. This can cause an instability or “jitter” in the frequency at or near the maximum, as the frequency is reduced or increased opportunistically. In previous and currently-available implementations, communications workloads have not benefitted from this feature because of the impact of frequency transitions on communications workloads.

Embodiments address these and other concerns by providing a mechanism to tune the system settings and core frequencies to achieve a consistent core frequency. Power parameters are tuned such that frequency transitions are minimized. Rather than being set to a maximum value, frequency is increased to just below a maximum such that a power headroom is maintained, and a stable frequency point is found to maintain power within that power headroom. Therefore, frequency will never or only rarely be at risk of increasing above this maximum, and there may be no or minimal need to “walk back” (e.g., “reverse”) a frequency increase. A stable frequency can then be maintained while still taking advantage of boosting to at least some extent. Stable frequency is defined based on power headroom available and accordingly there is no fixed percentage or range in which a frequency can be said to be “stable.” Methods according to embodiments can be implemented in firmware or software, for example, in ODM/OEM platforms, in CPU firmware, or via a software tuning agent (delivered as a SaaS option, in licensed or open source software).

Methods according to embodiments can be configurable at run time, for example via user input device or display, and can be disabled or enabled based on user or operator preference. Methods according to embodiments can detect opportunities for achieving higher than advertised typical stable frequency. At least two separate and distinct modes can be provided in embodiments. These can include 1.) identification of a frequency tuning opportunity and providing a recommendation that higher frequency can be stabilized, and 2.) auto-tuning mode wherein the controller applies the recommendation without user interaction.

The first (identification) mode can be implemented in software or firmware, wherein a controller (e.g., processing circuitry described later herein) can detect whether compute systems or cores are hitting power limits or whether frequency is fluctuating. If one or both of these conditions is present, a recommendation can be generated and provided (e.g., to a user or operator) to implement frequency stabilization. In a second (auto-tuning) mode, if workload is I/O centric workloads (e.g., high (mesh (interconnect)/NIC) bandwidth or core is polling at or near a maximum), then an automated recipe can be activated wherein a stable frequency is determined based on the workload, number of active cores, etc. In at least this (second, auto-tuning) mode, other parameters can be configured, tuned or set, including frequencies outside of the core frequencies, other energy parameters, and frequency modulation to maintain power to minimize the frequency transitions.

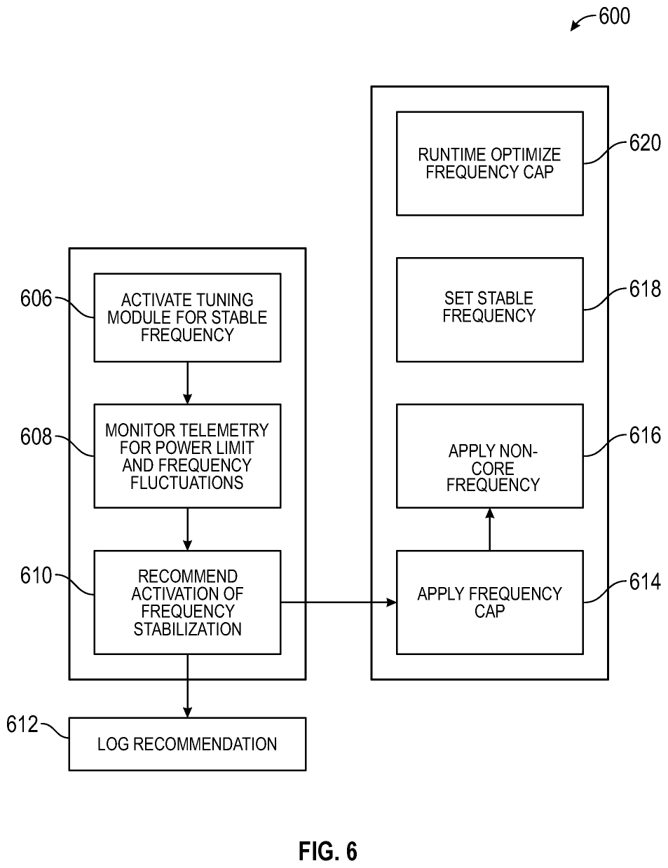

FIG. 6 illustrates a flow diagram of a method 600 for stabilizing frequency according to example embodiments. Overall flow and detection are shown in FIG. 6.

At block 606, frequency boosting is enabled to achieve higher performance for low latency workloads. At block 608, control circuitry can monitor frequency transitions and data fabric counters to detect whether frequencies are stable in a system or subset of a system. Other detection can include detection of whether a workload is network-centric because performance of such workloads may be impacted more readily by frequency transitions. If frequency tuning would be helpful to achieve stable frequency, then frequency stabilization actions are recommended at block 610. In cases of non-automated tuning, the recommendation can be logged at block 612.

Otherwise processing proceeds to block 614, at which a frequency cap is applied for stabilization of frequency. If tuning is required, tuning can proceed at block 616 based on whether frequency adjustment outside of the cores is available. Power parameters can be tuned to minimize the frequency transitions. Core frequencies can be fixed in block 618, and in some examples frequencies outside of the cores can be fixed. In other examples, boosting can be disabled, or performance biasing can be set. Frequencies can also be capped at runtime for further optimization at block 620. More details on how each of the tuning parameters minimizes the frequency transitions is explained in later sections.

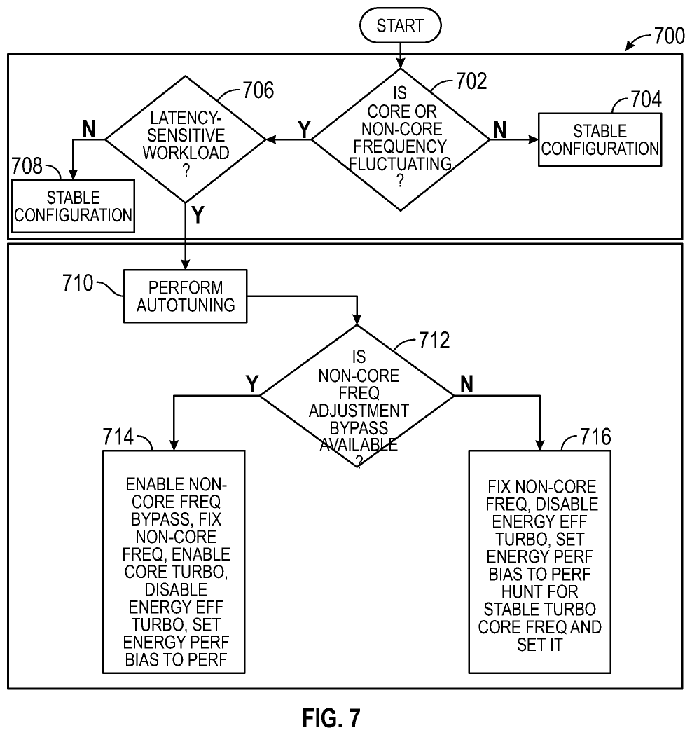

FIG. 7 further illustrates decision points and other details of a method 700 for stabilizing frequency according to some embodiments. At block 702, control circuitry can determine if core frequencies or frequencies outside the core are fluctuating, where determination of this fluctuation can vary depending on power level, e.g., stable frequency is defined based on power headroom available and accordingly there is no fixed percentage or range in which a frequency can be said to be “stable.” If not, the control circuitry determines that the system configuration is stable at block 704 and no further action is taken. Otherwise, the control circuitry determines if the workload is a latency sensitive workload at block 706. For example, network workloads can be latency sensitive and would benefit from stabilized frequency. The workload may be determined to be a network workload by monitoring sensors and counters in the CPU, and whether there is input and output traffic in the fabric.

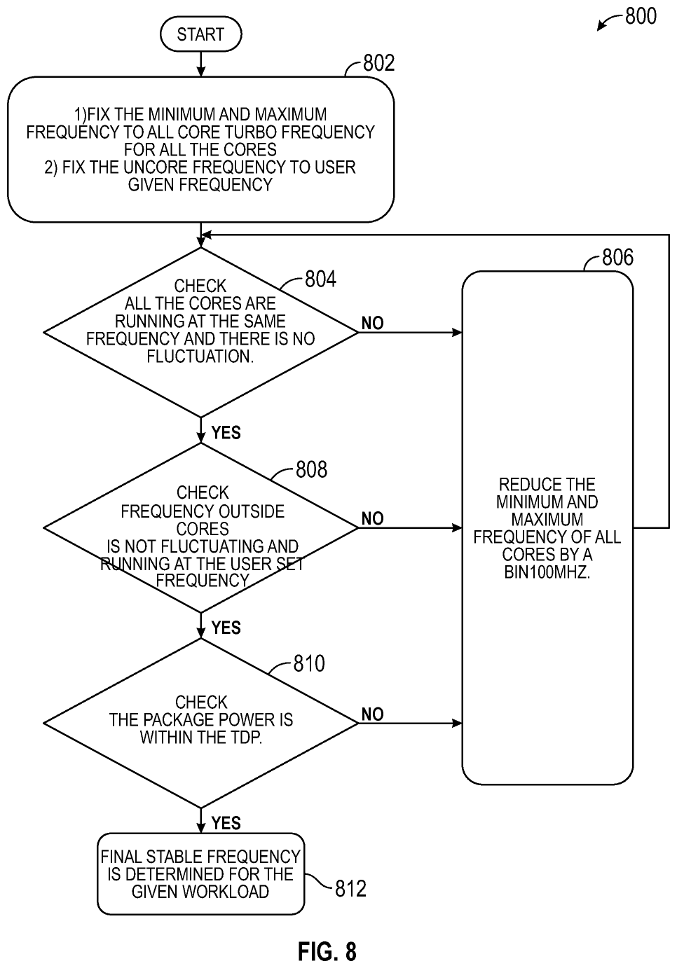

If the workload is not latency-sensitive, at block 708, no further action is taken. Otherwise, autotuning similar to blocks 614 and 616 (FIG. 6) are undertaken at block 710. At block 712, if frequencies of components outside of the core can be bypassed, e.g., if the platform includes hooks for changing frequencies of components outside the core, as determined at block 712, then bypass is enabled, and other tuning functions can be performed at block 714. Otherwise, at block 716, tuning functions are performed without enabling bypass. Further detail on tuning functions is provided in FIG. 8.

FIG. 8 illustrates tuning 800 wherein various parameters are adjusted and tuned to achieve stable frequency in accordance with some embodiments. Tuning 800 shows further detail of block 710 (FIG. 7). Parameters can include core frequencies, frequencies of components outside the core, disabling or enabling energy efficient way to increase frequency, setting energy performance bias to a performance mode setting, running average power limits (RAPL) for cores and components outside the core, etc. similar to those listed in blocks 714 and 716 (FIG. 7). At block 802, minimum and maximum core frequency thresholds are set, and frequencies of components outside the core/s can be set based on user preference or other preferences and parameters. Preferred maximum and minimum frequencies can be stored as parameters in a memory. At block 804, control circuitry can determine whether cores are running at a same, stable frequency. If not, minimum and maximum frequencies can be reduced at block 806. The reduction can be by a same amount or different amounts in any iteration of method 800 depending on the number of cores, the workload, or any other criteria. Different workloads can also be given different priorities and as such the frequencies can be adjusted by different amounts for different workloads. Frequencies of components other than the core/s are also checked at block 808 and similarly, if there is instability the minimum and maximum frequencies can be reduced. Operations at block 806 can minimize fluctuations as described above, by reducing or eliminating any “walking back” of frequency increases near an upper limit.

At block 810, the control circuitry determines whether package power is within thermal thresholds and if not, minimum and maximum frequencies are reduced at block 806. At block 812, method 800 concludes in at least one iteration with a fixed stable frequency for the given workload. In some embodiments, different workloads can be controlled differently. Method 800 can be iterative and performed for multiple workloads simultaneously by control circuitry in real-time. Each core and component outside the core/s can run at separate frequencies.

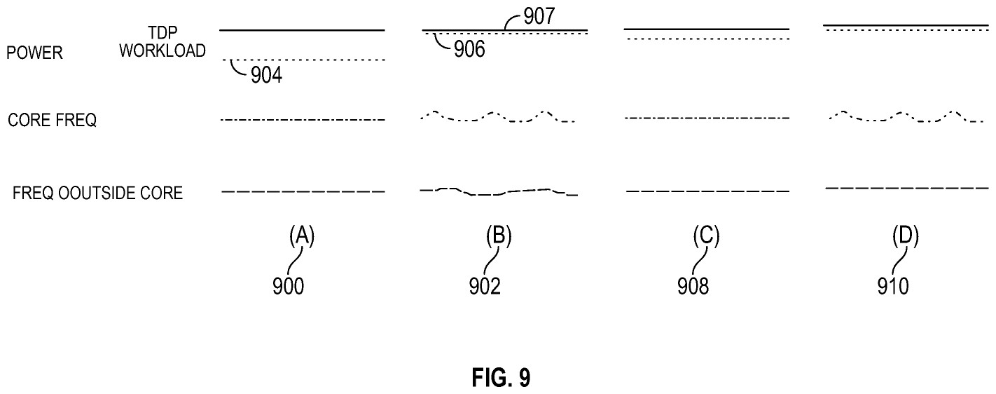

FIG. 9 illustrates workload configuration scenarios according to some embodiments. Four different workload configuration scenarios are shown, although embodiments are not limited thereto. Scenario 900 is a scenario in which no boosting is performed and scenario 902 illustrates a currently available boosting scenario in which power is near to maximum level. In scenario 900, a threshold 904 is maintained below thermal design power (TDP), e.g., much lower than the threshold used in scenario 906, which is maintained near maximum (or TDP) 907. Accordingly, core frequency and frequency of components outside the core/s are maintained in a more stable fashion in scenario 900 versus scenario 902 but not all available power is used in scenario 900, whereas all or most available power is consumed in scenario 902.

In scenario 908, with an auto tuning methodology or algorithm in which boosting is performed, a power budget below TDP is allowed so that core frequency and frequencies of components outside the core/s do not fluctuate. In contrast, in scenario 910, power is allowed to go much higher and therefore core frequencies fluctuate more than in scenario 908. Scenario 910 may represent a latency-sensitive workload, as discussed with respect to block 714 (FIG. 7). Power is maintained by adjusting core frequency but frequency of component/s outside the core/s is kept at one level. Control circuitry monitors the power to keep power close to limits or further away from limits in all four scenarios shown. Some power headroom may be maintained in scenario 908 but less or no power headroom is maintained in scenario 910, and accordingly more fluctuations can occur.

As briefly mentioned earlier herein, frequencies of component/s outside the core/s can be characterized by a base frequency and boost frequencies similar to the cores. As with cores, the frequencies can change depending on system configuration and load. In methods according to embodiments, frequency transitions of component/s outside the core/s are avoided or minimized to a greater extent than in cores, by fixing maximum frequency of these component/s substantially lower or lower than core frequency. This helps keep the overall power usage of the CPU under the TDP limits and provides power budget to core frequency. In embodiments, the frequency value for component/s outside the core/s can be fixed and not varied in example methods, by setting their frequency/frequencies via a processor interface.

In some embodiments, an Energy Efficient Turbo (EET) mode of operation can provide for adjusting a core frequency within the turbo range. This can be adjusted by a power control unit (PCU) based on how efficient increase in frequency is to increase in performance. There may be other mechanisms that automatically adjust core frequency. This mode can be disabled using system parameters to reduce unwanted core frequency transitions.

In some embodiments, a parameter for performing or setting Energy Performance Bias (EPB) can control the energy efficiency policy in the CPU. The energy efficiency policy can be set to specify preference with respect to power-performance tradeoffs. In embodiments, the energy performance bias can be set to a “performance” mode by setting system parameters to achieve good performance. Generally, several automatic mechanisms can exist for improving energy efficiency that changes core frequencies and frequencies of components outside the core/s. However, these mechanisms are disabled to avoid changes in frequency outside of example embodiments.

By implementing methods according to various embodiments, L1 throughput performance can be improved for some of the frame sizes when compared with other boosting algorithms available in systems, in addition to other improvements described above.

### Other Apparatuses

In further examples, any of the compute nodes or devices discussed with reference to the present edge computing systems and environment may be fulfilled based on the components depicted in FIGS. 10A and 10B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 10A, an edge compute node 1000 includes a compute engine (also referred to herein as “compute circuitry”) 1002, an input/output (I/O) subsystem 1008, data storage 1010, a communication circuitry subsystem 1012, and, optionally, one or more peripheral devices 1014. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The computer node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 and a memory 1006. Other components e.g., fabric or interhost fabric components may lie between processor 1004 and memory 1006, and between processor 1004 and I/O subsystem 1008. The processor 1004 may be embodied as any type of processor capable of performing the functions described herein (e.g., executing an application). For example, the processor 1004 may be embodied as a multi-core processor(s), a microcontroller, or other processor or processing/controlling circuit. In some examples, the processor 1004 may be embodied as, include, or be coupled to an FPGA, an application specific integrated circuit (ASIC), reconfigurable hardware or hardware circuitry, or other specialized hardware to facilitate performance of the functions described herein.

The memory 1006 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1006 may be integrated into the processor 1004. The memory 1006 may store various software and data used during operation such as one or more applications, data operated on by the application(s), libraries, and drivers.

The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the memory 1006, and other components of the compute circuitry 1002, into the compute circuitry 1002. Subsystem 1008 is an example of a component outside the processor core/s for which frequency is managed.

The one or more illustrative data storage devices 1010 may be embodied as any type of devices configured for short-term or long-term storage of data such as, for example, memory devices and circuits, memory cards, hard disk drives, solid-state drives, or other data storage devices. Individual data storage devices 1010 may include a system partition that stores data and firmware code for the data storage device 1010. Individual data storage devices 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device (e.g., an edge gateway of an implementing edge computing system). The communication circuitry 1012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device (e.g., an edge gateway node). In some examples, the NIC 1020 may be embodied as part of a system-on-a-chip (SoC) that includes one or more processors, or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally, or alternatively, in such examples, the local memory of the NIC 1020 may be integrated into one or more components of the client compute node at the board level, socket level, chip level, and/or other levels.

Additionally, in some examples, a respective compute node 1000 may include one or more peripheral devices 1014. Such peripheral devices 1014 may include any type of peripheral device found in a compute device or server such as audio input devices, a display, other input/output devices, interface devices, and/or other peripheral devices, depending on the particular type of the compute node 1000. In further examples, the compute node 1000 may be embodied by a respective edge compute node (whether a client, gateway, or aggregation node) in an edge computing system or like forms of appliances, computers, subsystems, circuitry, or other components.

In a more detailed example, FIG. 10B illustrates a block diagram of an example of components that may be present in an edge computing node 1050 for implementing the techniques (e.g., operations, processes, methods, and methodologies) described herein. This edge computing node 1050 provides a closer view of the respective components of node 1000 when implemented as or as part of a computing device (e.g., as a mobile device, a base station, server, gateway, etc.). The edge computing node 1050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1050, or as components otherwise incorporated within a chassis of a larger system.

The edge computing device 1050 may include processing circuitry in the form of a processor 1050, which may be a microprocessor, a multi-core processor, a multithreaded processor, an ultra-low voltage processor, an embedded processor, or other known processing elements. The processor 1050 may be a part of a system on a chip (SoC) in which the processor 1050 and other components are formed into a single integrated circuit, or a single package, such as the Edison™ or Galileo™ SoC boards from Intel Corporation, Santa Clara, Calif. As an example, the processor 1050 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARMED-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1052 and accompanying circuitry may be provided in a single socket form factor, multiple socket form factor, or a variety of other formats, including in limited hardware configurations or configurations that include fewer than all elements shown in FIG. 10B.

The processor 1052 may communicate with a system memory 1054 over an interconnect 1056 (e.g., a bus), and the interconnect 1056 is an example of a component outside the core/s of which frequency is managed. Any number of memory devices may be used to provide for a given amount of system memory. As examples, the memory 1054 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1056 may couple the processor 1052 to a transceiver 1066, for communications with the connected edge devices 1062. The transceiver 1066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1066 (or multiple transceivers) may communicate using multiple standards or radios for communications at a different range. For example, the edge computing node 1050 may communicate with close devices, e.g., within about 10 meters, using a local transceiver based on Bluetooth Low Energy (BLE), or another low power radio, to save power. More distant connected edge devices 1062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1066 (e.g., a radio transceiver) may be included to communicate with devices or services in the edge cloud 1095 via local or wide area network protocols. The wireless network transceiver 1066 may be a low-power wide-area (LPWA) transceiver that follows the IEEE 802.15.4, or IEEE 802.15.4g standards, among others. The edge computing node 1050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1066, as described herein. For example, the transceiver 1066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1068 may be included to provide a wired communication to nodes of the edge cloud 1095 or to other devices, such as the connected edge devices 1062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to enable connecting to a second network, for example, a first NIC 1068 providing communications to the cloud over Ethernet, and a second NIC 1068 providing communications to other devices over another type of network.

Given the variety of types of applicable communications from the device to another component or network, applicable communications circuitry used by the device may include or be embodied by any one or more of components 1064, 1066, 1068, or 1070. Accordingly, in various examples, applicable means for communicating (e.g., receiving, transmitting, etc.) may be embodied by such communications circuitry.

The edge computing node 1050 may include or be coupled to acceleration circuitry 1064, which may be embodied by one or more artificial intelligence (AI) accelerators, a neural compute stick, neuromorphic hardware, an FPGA, an arrangement of GPUs, an arrangement of data processing units (DPUs) or Infrastructure Processing Units (IPUs), one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, global navigation system (e.g., GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1076 may power the edge computing node 1050, although, in examples in which the edge computing node 1050 is mounted in a fixed location, it may have a power supply coupled to an electrical grid, or the battery may be used as a backup or for temporary capabilities. The battery 1076 may be a lithium ion battery, or a metal-air battery, such as a zinc-air battery, an aluminum-air battery, a lithium-air battery, and the like.

A battery monitor/charger 1078 may be included in the edge computing node 1050 to track the state of charge (SoCh) of the battery 1076, if included. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) converter that enables the processor 1052 to directly monitor the voltage of the battery 1076 or the current flow from the battery 1076. The battery parameters may be used to determine actions that the edge computing node 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the edge computing node 1050. A wireless battery charging circuit, such as an LTC4020 chip from Linear Technologies of Milpitas, Calif., among others, may be included in the battery monitor/charger 1078. The specific charging circuits may be selected based on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1082 on the processor 1052 (separately, or in combination with the instructions 1082 of the machine readable medium 1060) may configure execution or operation of a trusted execution environment (TEE) 1090. In an example, the TEE 1090 operates as a protected area accessible to the processor 1052 for secure execution of instructions and secure access to data. Various implementations of the TEE 1090, and an accompanying secure area in the processor 1052 or the memory 1054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1050 through the TEE 1090 and the processor 1052.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Additional Notes and Aspects

Example 1 is an apparatus comprising: a plurality of processor cores; and control circuitry coupled to the plurality of processor cores, the control circuitry configured to: detect at least one of a power characteristic and a frequency characteristic of at least one of the plurality of processor cores; determine that a frequency control opportunity is present on at least one of the plurality of processor cores based on at least one of the power characteristic and the frequency characteristic; and adjust a power parameter of at least one of the plurality of processor cores responsive to determining that the frequency control opportunity is present.

In Example 2 the subject matter of Example 1 can optionally include wherein the frequency characteristic corresponds to stability of operating frequency of at least one of the plurality of processor cores, and wherein the control circuitry is configured to determine that the frequency control opportunity is present upon detecting that at least one of the plurality of processor cores has an unstable operating frequency.

In Example 3, the subject matter of any of Examples 1-2 can optionally include wherein the control circuitry is configured to determine that the frequency control opportunity is present upon detecting that a power threshold has been met or exceeded.

In Example 4, the subject matter of any of Examples 1-3 can optionally include wherein adjusting the power parameter comprises setting a frequency of operation of at least one of the plurality of processor cores.

In Example 5, the subject matter of any of Examples 1-4 can optionally include wherein adjusting the power parameter comprises fixing a frequency of operation of a portion of the apparatus outside the plurality of processor cores.

In Example 6, the subject matter of Example 5 can optionally include wherein the portion includes at least one of a power controller unit (PCU) and an integrated memory controller (MC) of the apparatus.

In Example 7, the subject matter of any of Examples 1-6 can optionally include wherein the control circuitry is configured to initialize a frequency of operation of the plurality of processor cores.

In Example 8, the subject matter of any of Examples 1-7 can optionally include wherein the control circuitry is configured to initialize a frequency of operation of a portion of the apparatus outside the plurality of processor cores.

In Example 9, the subject matter of Example 8 can optionally include wherein the frequency of operation is based on a user preference for a user of the apparatus.

In Example 10, the subject matter of Example 8 can optionally include wherein the portion includes at least one of a cache/home agent, a power controller unit (PCU) and an integrated memory controller (MC) of the apparatus.

Example 11 is a system comprising memory; a plurality of processor cores; and control circuitry coupled to the plurality of processor cores, the control circuitry configured to: detect at least one of a power characteristic and a frequency characteristic of at least one of the plurality of processor cores; determine that a frequency control opportunity is present on at least one of the plurality of processor cores based on at least one of the power characteristic and the frequency characteristic; and adjust a power parameter of at least one of the plurality of processor cores responsive to determining that the frequency control opportunity is present.

In Example 12, the subject matter of Example 11 can optionally include wherein the frequency characteristic corresponds to stability of operating frequency of at least one of the plurality of processor cores, and wherein the control circuitry is configured to determine that the frequency control opportunity is present upon detecting that at least one of the plurality of processor cores has an unstable operating frequency.

In Example 13, the subject matter of any of Examples 11-12 can optionally include wherein the control circuitry is configured to determine that the frequency control opportunity is present upon detecting that a power threshold has been met or exceeded.

In Example 14, the subject matter of any of Examples 11-13 can optionally include wherein adjusting the power parameter comprises setting an operational frequency of at least one of the plurality of processor cores.

In Example 15, the subject matter of any of Examples 11-14 can optionally include wherein adjusting the power parameter comprises fixing a frequency of operation of a portion of the system outside the plurality of processor cores.

In Example 16, the subject matter of Example 15 can optionally include wherein adjusting the power parameter comprises fixing a frequency of operation of at least one of a cache/home agent, a power controller unit (PCU) and an integrated memory controller (MC) of the system.

In Example 17, the subject matter of any of Examples 11-16 can optionally include a user display and a user input device, and wherein the user display is configured to receive a user input to disable or enable adjusting the power parameter.

In Example 18, the subject matter of any of Examples 11-17 can optionally include wherein at least a portion of the system is incorporated in a data center.

In Example 19, the subject matter of Example 18 can optionally include wherein the data center includes racks.

Example 20 is a machine-readable medium having stored thereon instructions that, when implemented on a machine, cause the machine to perform operations including: detecting at least one of a power characteristic and a frequency characteristic of at least one of a plurality of processor cores; determining that a frequency control opportunity is present on at least one of the plurality of processor cores based on at least one of the power characteristic and the frequency characteristic; and adjusting a power parameter of at least one of the plurality of processor cores responsive to determining that the frequency control opportunity is present.

In Example 21, the subject matter of Example 20 can optionally include wherein the frequency characteristic corresponds to stability of operating frequency of at least one of the plurality of processor cores, and wherein the operations further include determining that the frequency control opportunity is present upon detecting that at least one of the plurality of processor cores has an unstable operating frequency; and adjusting an operating frequency of at least one of the plurality of processor cores responsive to the detecting.

In Example 22, the subject matter of any of Examples 20-21 can optionally include wherein the operations further comprise determining that the frequency control opportunity is present upon detecting that a power threshold has been met or exceeded.

In Example 23, the subject matter of nay of Examples 20-22 can optionally include wherein the operations are executed in a data center including racks.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. An apparatus comprising:
a plurality of processor cores; and
control circuitry coupled to the plurality of processor cores, the control circuitry configured to:
detect at least one of a power characteristic and a frequency characteristic of at least one of the plurality of processor cores;
determine that a frequency control opportunity is present on at least one of the plurality of processor cores based on at least one of the power characteristic and the frequency characteristic; and
adjust a power parameter of at least one of the plurality of processor cores responsive to determining that the frequency control opportunity is present.

2. The apparatus of claim 1, wherein the frequency characteristic corresponds to stability of operating frequency of at least one of the plurality of processor cores, and wherein the control circuitry is configured to determine that the frequency control opportunity is present upon detecting that at least one of the plurality of processor cores has an unstable operating frequency.

3. The apparatus of claim 1, wherein the control circuitry is configured to determine that the frequency control opportunity is present upon detecting that a power threshold has been met or exceeded.

4. The apparatus of claim 1, wherein adjusting the power parameter comprises setting a frequency of operation of at least one of the plurality of processor cores.

5. The apparatus of claim 1, wherein adjusting the power parameter comprises fixing a frequency of operation of a portion of the apparatus outside the plurality of processor cores.

6. The apparatus of claim 5, wherein the portion includes at least one of a power controller unit (PCU) and an integrated memory controller (MC) of the apparatus.

7. The apparatus of claim 1, wherein the control circuitry is configured to initialize a frequency of operation of the plurality of processor cores.

8. The apparatus of claim 1, wherein the control circuitry is configured to initialize a frequency of operation of a portion of the apparatus outside the plurality of processor cores.

9. The apparatus of claim 8, wherein the frequency of operation is based on a user preference for a user of the apparatus.

10. The apparatus of claim 8, wherein the portion includes at least one of a cache/home agent, a power controller unit (PCU) and an integrated memory controller (MC) of the apparatus.

11. A system comprising:
memory;
a plurality of processor cores; and
control circuitry coupled to the plurality of processor cores, the control circuitry configured to:
detect at least one of a power characteristic and a frequency characteristic of at least one of the plurality of processor cores;
determine that a frequency control opportunity is present on at least one of the plurality of processor cores based on at least one of the power characteristic and the frequency characteristic; and
adjust a power parameter of at least one of the plurality of processor cores responsive to determining that the frequency control opportunity is present.

12. The system of claim 11, wherein the frequency characteristic corresponds to stability of operating frequency of at least one of the plurality of processor cores, and wherein the control circuitry is configured to determine that the frequency control opportunity is present upon detecting that at least one of the plurality of processor cores has an unstable operating frequency.

13. The system of claim 11, wherein the control circuitry is configured to determine that the frequency control opportunity is present upon detecting that a power threshold has been met or exceeded.

14. The system of claim 11, wherein adjusting the power parameter comprises setting an operational frequency of at least one of the plurality of processor cores.

15. The system of claim 11, wherein adjusting the power parameter comprises fixing a frequency of operation of a portion of the system outside the plurality of processor cores.

16. The system of claim 15, wherein adjusting the power parameter comprises fixing a frequency of operation of at least one of a cache/home agent, a power controller unit (PCU) and an integrated memory controller (MC) of the system.

17. The system of claim 11, further comprising a user display and a user input device, and wherein the user display is configured to receive a user input to disable or enable adjusting the power parameter.

18. The system of claim 11, wherein at least a portion of the system is incorporated in a data center.

19. The system of claim 18, wherein the data center includes racks.

20. A machine-readable medium having stored thereon instructions that, when implemented on a machine, cause the machine to perform operations including:
detecting at least one of a power characteristic and a frequency characteristic of at least one of a plurality of processor cores;
determining that a frequency control opportunity is present on at least one of the plurality of processor cores based on at least one of the power characteristic and the frequency characteristic; and
adjusting a power parameter of at least one of the plurality of processor cores responsive to determining that the frequency control opportunity is present.

21. The machine-readable medium of claim 20, wherein the frequency characteristic corresponds to stability of operating frequency of at least one of the plurality of processor cores, and wherein the operations further include determining that the frequency control opportunity is present upon detecting that at least one of the plurality of processor cores has an unstable operating frequency; and adjusting an operating frequency of at least one of the plurality of processor cores responsive to the detecting.

22. The machine-readable medium of claim 20, wherein the operations further comprise determining that the frequency control opportunity is present upon detecting that a power threshold has been met or exceeded.

23. The machine-readable medium of claim 20, wherein the operations are executed in a data center including racks.
